(19) United States
(12) Patent Application Publication
(10) Pub. No.: US 2011/0251880 A1
(43) Pub. Date: Oct. 13, 2011

(54) VIRAL COUPON INFRASTRUCTURE

(76) Inventors: John Christopher Butler, London (GB); Rufus Simon Tobias Evison, London (GB)

(21) Appl. No.: 12/756,385

(22) Filed: Apr. 8, 2010

(51) Int. Cl. G06Q 30/00; G06F 17/30; G06Q 50/00; G06Q 10/00; G06Q 99/00

(52) U.S. Cl. 705/14.13; 705/14.22; 705/14.23; 705/14.25; 705/14.26; 707/802; 707/E17.044

(57) ABSTRACT

Methods, systems, devices and/or apparatus related to generating, transmitting and/or tracking coupons. Specifically, the disclosed methods, systems, devices and/or apparatus relate to generating, transmitting and/or tracking a plurality of coupons among a plurality of consumers using social media channels and other electronic distribution channels. Some exemplary embodiments may include authenticating consumers and/or coupons.

### BACKGROUND

Many marketers believe in the superior persuasive ability of “word of mouth” marketing. Due to the recent surge in Internet use (including email, text messaging, mobile web connectivity and social media websites and services such as MYSPACE®, FACEBOOK®, TWITTER®, and the like), marketers recognize social media as a digital platform that may expand the impact of word of mouth marketing. Such increased Internet usage also makes word of mouth marketing measurable and, therefore, “budget-able.” Social media is a growing global phenomenon.

Given that social media is now a viable channel with genuine global reach, it makes sense to provide mechanisms to efficiently harness its word of mouth marketing power. One advantage of word of mouth marketing is the element of “trusted sources” that receiving information from friends and/or acquaintances may provide. Friends know each other and likely know what their friends may be interested in. Many times, if a friend recommends a product or service, it may be worthy of notice.

Therefore, marketers may desire to harness the power and reach that social media (and, more generally, the Internet) provides. In this manner, marketers may more effectively target consumers with coupons, offers, advertisements and the like.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a diagram depicting an example embodiment of the present invention.

FIG. 2 is a flow diagram depicting an example embodiment of the present invention.

FIG. 3 is a flow diagram depicting another example embodiment of the present invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. A component can be localized on one computer and/or distributed between two or more computers. Likewise, as used in this application, the term “database” is intended to refer to one or more computer-related entities for the storage and access of data; and does not necessarily pertain to any manner or structure in which such data is stored. Further, the recitation of a first database and a second database does not necessarily require that such databases are separate from one another, either with respect to the data storage location(s), device(s) and/or structure(s).

As used herein, the term “widget” generally refers to a software-based component of any graphical user interface (whether it be on a computer, a web-site, a mobile device, a hand-held device and the like) in which the user interacts. For example, a widget may be a graphical user interface element that may display an information arrangement capable of being changed by a consumer, such as a window or a text box. A widget may provide a single interaction point for manipulating a given kind of data. In one example, a widget may include a web widget (which may include any code that may be embedded within a page of HTML, e.g., a web page).

This disclosure is drawn to methods, systems, devices and/or apparatus related to generating, transmitting and/or tracking coupons and other redeemable incentives and/or promotions (collectively, “coupons”). Specifically, the disclosed methods, systems, devices and/or apparatus relate to generating, transmitting and/or tracking a plurality of coupons among a plurality of consumers using social media channels and other electronic distribution channels.

The present disclosure contemplates that, in certain embodiments, retail stores may already have an existing membership (or reward) program. Many membership programs reward consumers for purchasing products in a certain retail store. Many membership programs also provide the ability for a consumer to visit a coupon site (such as the retailer's website or a third party website, for example) to collect coupons. In this manner or in many other manners described herein, consumers may automatically associate (or “add”) coupons with their member number. It should be noted that the terms “identification number” and “member number,” as used herein, shall not be limited to numerals, and may include any alphanumeric characters and/or other symbols or identifiers.

The present disclosure also contemplates that, in certain embodiments, consumers may be members of, or have accounts with, certain types of clubs (e.g., automobile clubs and couponing clubs), associations (e.g., professional associations), programs (e.g., fund-raising programs) and/or financial institutions (e.g., credit cards) that are not necessarily associated with a specific retail store or outlet, but may partner with and/or have associations with many different retail stores or outlets (collectively, such clubs, associations, programs and financial institutions will be referred to herein as “incentive programs”). These incentive programs may provide coupons (redeemable, for example, with such partnering retail outlets) in multiple ways to its members so that such coupons may be associated with the members' member numbers.

In an example embodiment, a widget may allow a consumer to offer a coupon to another consumer provided that both are registered (or become registered) with the same entity, such as a retail store or incentive program. In one example, offering a coupon to another consumer may be accomplished by creating an exchange widget. Such a widget may allow a consumer to select a coupon from any of a variety of sources (e.g., the retailer's or incentive program's website, a third party website or a member coupon bank). After selecting a coupon to share, a consumer may then click (using a mouse click or other input device, for example) “give this coupon to a friend”. In one example, the consumer may then be prompted to input contact details for his/her “friend.” Contact details may include the friend's name, email address, telephone number, social media account name(s), and/or other similar information. The consumer's friend may then receive a message (an email, text message, social media message and/or the like, depending on the contact information inputted by the consumer, for example) notifying them that the consumer has sent them a coupon. The message may also ask the friend if they would like to accept the coupon. In accepting the coupon, an opportunity to “opt in” to receiving other targeted coupons from the retail store or incentive program, and/or other marketing messages and services may also be provided. In one embodiment, the friend may be prompted to supply their member number they wish to load the coupon on to in order to accept. In some embodiments, the member number may be supplied automatically when the friend is logged into the retailer's or incentive program's website, third party website or member coupon bank. If the friend does not have a retail store or incentive program member number, an opportunity to register may be presented. In one embodiment, if the user is logged in to the retail store or incentive program website, upon accepting the coupon, the coupon would automatically be loaded onto (linked with) their member number.

In light of the above example, it is envisioned with embodiments described herein the exchange, distribution and/or transmission of coupons does not necessarily involve the exchange, distribution and/or transmission of an actual physical or printable coupon itself, but can involve the exchange, distribution and/or transmission of ownership and/or access information to a coupon as handled by a coupon tracking component, for example. For example, the act(s) of transmitting a coupon from customer A to customer B could start with the coupon ownership information being associated with customer A's member number (e.g., loyalty card number); followed by a coupon transfer email or other electronic message from customer A to customer B, in which customer B may be taken to a web-site so that customer B can “accept” the transfer of the coupon to customer B by activating an “accept” icon provided by the website (the ability to accept may also be provided within the received message itself); and, upon activation of the “accept” icon, the system transferring the coupon's ownership information from customer A's account to customer B's account. Consequently, when customer B has his/her loyalty card scanned during a subsequent transaction (or when customer B associates his/her account or member number with a transaction in any other manner) at the participating retailer, that transferred coupon could then be applied/redeemed to that transaction, if applicable.

In some embodiments, consumers with a history of being loyal to a specific brand or type of product may be provided a set of coupons in their accounts. These may include one or more “high value” coupons that may only be used by that consumer, and one or more “smaller value” coupons that may not be used by that consumer. In that case, the smaller value coupons would not be able to be used in connection with that consumer's member number, but would be able to be used by that consumer's friends in connection with the friends' member number. Abuse of such a system may be limited by providing “single use” coupons that expire after being redeemed once, or “limited use” coupons that expire after being redeemed a predetermined number of times.

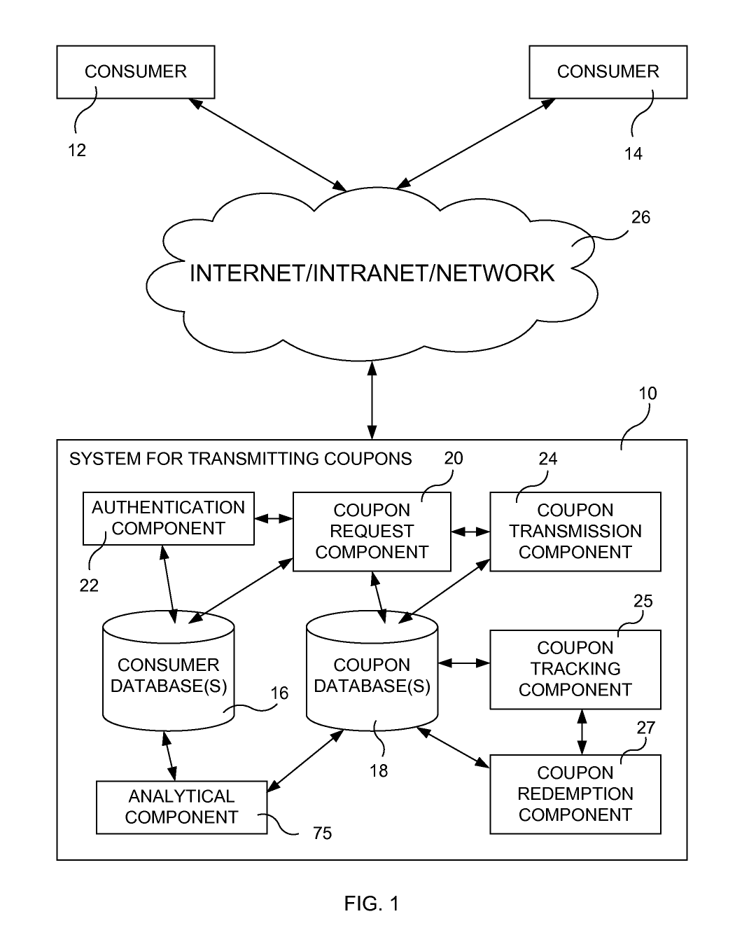

In an example embodiment (as depicted in FIG. 1), a system 10 for transmitting coupons among consumers 12, 14 is provided. Such a system 10 may include consumer database(s) 16, coupon database(s) 18, a coupon request component 20, an authentication component 22, a coupon transmission component 24, a coupon tracking component 25 and a coupon redemption component 27. The consumer database 16 may store and/or link consumer data related to a consumer's 12, 14 biographical information, contact information, identifying information and/or membership information. The coupon database 18 may store and/or link coupon data related to the coupons (which may include product discounts, product offers and/or product advertisements). The coupon request component 20 may receive a request from a consumer 12 to transmit a coupon to another consumer 14. The authentication component 22 may communicate with the consumer database 16 to authenticate the transmitting consumer 12. Authentication may be based on the consumer data stored in consumer database 16. The authentication component 22 may also authenticate the receiving consumer 14 based on the consumer data stored in the consumer database 16. The coupon transmission component 24 may transmit the requested coupon (ownership/access information) to the receiving consumer 14 upon authentication of both consumers 12, 14. The coupon tracking component 25 may associate the coupons with the consumers. The coupon tracking component 25 may also store the associations (e.g., which consumers are associated with which coupons) in the coupon database. The coupon tracking component may also include algorithms and other components/functionality for controlling dissemination, activation and/or redemption of coupons based upon past events for which the coupon was involved (e.g., as explained in an example below, limiting transmission of the coupon to N recipients and/or N transmission from an initial consumer) and/or based upon preset limits and/or controls applied to the coupons (e.g., one-time-use coupons or limiting the number of transfers of a coupon, etc. as described herein). The coupon redemption component 27 may communicate with retailers to coordinate the redemption or attempted redemption of coupons with such retailers; and may also coordinate with the coupon tracking 25 component and/or the coupon database 18 to determine whether the consumer attempting to redeem the coupon is the present owner/possessor of the coupon and to remove the coupon association when redeemed, if necessary.

Consumers 12, 14 may interact with the system 10 through a communication network 26 such as the Internet, an Intranet, a cellular network, or other similar data network(s). Consumers 12, 14 may interact with the system 10 using any device capable of communication, including, without limitation, mobile devices (such as mobile phones), computer systems, hand-held wireless computing devices, microprocessor-based or programmable consumer electronics, and the like.

The coupon tracking component 25, the coupon request component 20 and/or the authentication component 22 may also include the functionality to reserve a coupon for a particular recipient, such as consumer 14 identified by consumer 12, so that only the particular recipient, or particular identified set of recipients, can accept a particular coupon. That is, if a recipient other than the identified recipient or set of recipients attempts to accept a transmitted coupon, the reserve functionality may refuse issuing the coupon to the other recipient. This reserve functionality could have time limits built in so that the coupon can only be accepted for a certain period of time. This reserve functionality could also have acceptance number limits built in such that only the first set of recipients (e.g. first five recipients to accept) can accept, and thereafter other attempts at acceptance would be denied. With any reserve functionality, it is also possible that, rather than denying the recipient any coupon or incentive, the functionality could be configured to issue to the recipient an alternative coupon or incentive reserved for those recipients denied issuance of the transmitted coupons. In one embodiment, this reserve functionality may be implemented by a coupon reservation component, which may be in communication with and/or integrated with the coupon tracking component 25, the coupon request component 20 and/or the authentication component 22.

In some embodiments, the coupon request component 20 may interface with a social media channel and/or an electronic communications channel. Social media channels may include a website, a widget, an application and/or computer-readable instructions, for example. Electronic communications channel may include a text messaging channel, a multimedia messaging channel and/or an email channel, for example.

In some embodiments, a consumer 12, 14 may be authenticated based on their biographical information, contact information, identifying information and/or membership information. An example embodiment may allow a consumer 12, 14 to provide this information to the system for authentication. In some examples, a consumer 12, 14 may provide an identification card/number, a reward card/number, a loyalty card/number, a membership card/number, a credit card/number, an electronic identification transmission (using near field communication protocols, for example), a mobile phone or mobile appliance identifier, and the like. In some embodiments, the authentication component 22 may base the consumer authentication, at least in part, on one or more of these items.

In some embodiments, the coupon tracking component 25 may store associations in the coupon database and/or the consumer database. In some embodiments, coupons may be associated with a unique coupon identifier stored in the coupon database 18. In some embodiments, each unique coupon identifier may be associated with only one of consumers 12, 14 at a time. In some examples, the coupon data may include the unique coupon identifier. In that case, upon transmitting the coupon to the receiving consumer 14, the unique coupon identifier may be associated with the receiving consumer 14 and disassociated with the transmitting consumer 12. In some examples, the coupon data associated with the transmitted coupon may be linked to the consumer data of the receiving consumer 14 and unlinked to the consumer data of the transmitting consumer 12. In some embodiments, the coupon redemption component will handle that the transmitted coupon may only be redeemed by the receiving consumer 14 if the coupon data for transmitted coupon is associated with the receiving consumer's 14 consumer data. In some embodiments, the coupon redemption component will handle that the transmitted coupon may only be redeemed by the receiving consumer 14 if the coupon data for transmitted coupon is associated with the receiving consumer 14. Some embodiments provide that, upon transmission of the requested coupon to the receiving consumer 14, the transmitting consumer 12 is restricted from redeeming the transmitted coupon. Some provide that, upon transmission of the requested coupon to the receiving consumer 14, the receiving consumer 14 is restricted from further transmitting the transmitted coupon. In some examples, a consumer 12, 14 may temporarily disassociate one or more coupons from their membership information to restrict usage of the coupon by the consumer 12, 14 (or related users of their membership). In some embodiments, a unique coupon identifier may be associated with more than one consumer at a time. In that case, for example, upon transmitting the coupon to the receiving consumer 14, the unique coupon identifier may be associated with the receiving consumer 14 and may remain associated with the transmitting consumer 12. Alternatively, the coupon may be transmitted to multiple receiving consumers, where the unique coupon identifier may be associated with each of the receiving consumers.

Coupons may include a plurality of coupons where one or more coupons are associated with the same product. In some examples, one or more of the coupons may provide a discount of greater value than the other coupons. In some examples, the coupons provided to the transmitting consumer 12 may be based on the transmitting consumer's 12 transaction history and/or tendency to purchase a certain product brand. Coupons may include manufacturer's coupon, retailer's coupon and/or other coupons. Coupons may include text, images, videos, links thereto or other similar media.

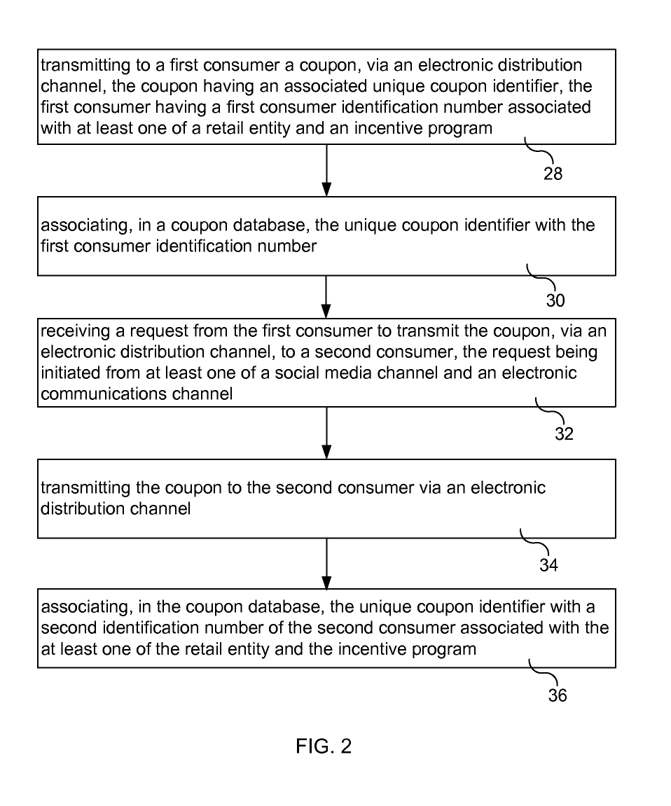

As depicted in FIG. 2, a method of transmitting a coupon associated with a product among consumers is provided. Such a method may include processing operations 28, 30, 32, 34, and/or 36. Operation 28 may include transmitting to a first consumer a coupon, via an electronic distribution channel, the coupon having an associated unique coupon identifier, the first consumer having a first consumer identification number associated with at least one of a retail entity and an incentive program. Continuing from operation 28, operation 30 may include associating, in a coupon database, the unique coupon identifier with the first consumer identification number. Operation 32 may include receiving a request from the first consumer to transmit the coupon, via an electronic distribution channel, to a second consumer, the request being initiated from at least one of a social media channel and an electronic communications channel. Operation 34 may include transmitting the coupon to the second consumer via an electronic distribution channel. Operation 36 may include associating, in the coupon database, the unique coupon identifier with a second identification number of the second consumer associated with the at least one of the retail entity and the incentive program.

In some examples, the unique coupon identifier may be disassociated from the first consumer identification number in the coupon database after or in conjunction with transmitting the coupon to the second consumer. In some examples, the method may also include redeeming the coupon to a transaction with a physical retail entity and/or a virtual retail entity by the second consumer using the second identification number. In some examples, the method may also include disassociating, in the coupon database, the unique coupon identifier from the second identification number after the coupon is redeemed by the second consumer. In some examples, the method may also include reserving the coupon for the second consumer (or set of consumers) to whom it was transferred such that the coupon can only be accepted and/or redeemed by the second consumer. In some examples, the method may also include the step of registering the second consumer with the retail entity and/or the incentive program so that the second identification number is assigned to the second consumer—where this step may occur prior to or substantially simultaneous with the step of associating the coupon in the database with the second consumer.

In some examples the method may further include the steps of receiving a request from the first consumer to transmit the coupon, via an electronic distribution channel, to another consumer, where the request is initiated from a social media channel and/or an electronic communications channel; transmitting the coupon to the other consumer via the electronic distribution channel; and associating, in the coupon database, the unique coupon identifier with an identification number of the other consumer associated with the retail entity and/or the incentive program.

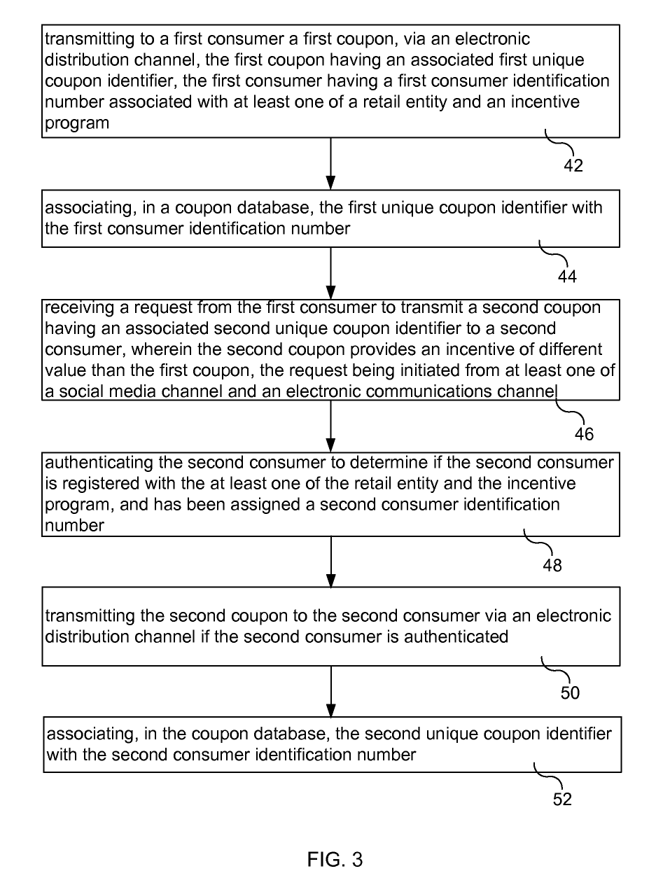

As depicted in FIG. 3, a method of transmitting a coupon associated with a product among consumers is provided. Such a method may include processing operations 42, 44, 46, 48, 50, 52, and/or 54. Operation 42 may include transmitting to a first consumer a first coupon, via an electronic distribution channel, the first coupon having an associated first unique coupon identifier, the first consumer having a first consumer identification number associated with at least one of a retail entity and an incentive program. As will be appreciated, this operation 42 does not necessarily need to be performed first. For example, as discussed herein, the first consumer may register with the retail store or incentive program after receipt of the coupon. Operation 44 may include associating, in a coupon database, the first unique coupon identifier with the first consumer identification number. Continuing from operation 44, operation 46 may include receiving a request from the first consumer to transmit a second coupon having an associated second unique coupon identifier to a second consumer, wherein the second coupon provides an incentive of different value than the first coupon, the request being initiated from at least one of a social media channel and an electronic communications channel. Operation 48 may include authenticating the second consumer to determine if the second consumer is registered with the at least one of the retail entity and the incentive program, and has been assigned a second consumer identification number. Operation 50 may include transmitting the second coupon to the second consumer via an electronic distribution channel if the second consumer is authenticated. Operation 52 may include associating, in the coupon database, the second unique coupon identifier with the second consumer identification number.

In some examples, the method further includes, prior to the step of transmitting the coupon to the second consumer, registering the second consumer with the retail store if the second consumer is not authenticated. This may include assigning the second consumer a second identification number. In some examples, the method includes redeeming the coupon to a purchase of the product by the second consumer using the second identification number. Some embodiments provide that, after redeeming the coupon, the unique coupon identifier is disassociated from the second identification number in the coupon database.

With respect to the above example embodiments that include a step of registering with a retail store or incentive program, it is possible that coupons could be usable across multiple retail outlets, in which case the consumer(s) could register with an incentive program that will allow for certain coupons to be redeemed through its member or partner retailers. For example, Restaurant A, Restaurant B and Restaurant C may be members of the coupon system controlled by the incentive program. When a user registers with the incentive program, the user may receive, share, and transmit coupons, such as “buy one get one free appetizer” that can be used at any of Restaurants A, B or C. Rather than being tied to a retailer's loyalty card, the coupons could be tied to an incentive program's coupon card, membership card, credit card and the like, the coupons could be tied to a mobile phone number, and/or the coupons can be tied to or any other form of identification, such as a passport number. When the consumer attempts to redeem the coupon at Restaurant B, for example, Restaurant B will have a mechanism for communicating with the incentive program for processing the redemption (or rejection) of the coupon.

In some embodiments, the method also includes redeeming the first coupon to a purchase of the product by the first consumer using the first identification number. In some embodiments, the method may also include, after redeeming the first coupon, disassociating, in the coupon database, the first unique coupon identifier from the first identification number. Some embodiments include redeeming the second coupon to a purchase of the product by the second consumer using the second identification number. Some embodiments provide that, after redeeming the second coupon, disassociating, in the coupon database, the second unique coupon identifier from the second identification number.

Some embodiments may also provide that coupons may be requested by, received by and transferred to non-members of the retail store program. In such embodiments, however, the coupon may only be redeemed by members of the retail store program. This would require such recipients (who likely do not often shop at the retail store) to visit the retail store and register with the retail store program to redeem the coupon. Thus, the use of such embodiments could increase store penetration where it is lacking. To encourage this practice, such shared or transmitted coupons could be of significant value (e.g., “free turkey!”) to influence the consumer to break from his/her pattern of shopping at other retail stores.

In some embodiments, the systems and methods described herein may provide increased engagement for consumers (including consumers sending coupons and consumers receiving coupons). Further, some embodiments may provide an analytical component 75 for the retail store or incentive program (and/or their marketing departments, affiliates, partners and/or agents) to analyze which consumers are offering what coupons to whom and which consumers are transferring, accepting, refusing and/or redeeming what coupons. These and/or other analytics may allow the retail store or incentive program to determine which consumers have great influence, who is receptive to receiving and/or redeeming coupons via electronic channels, who is or is not a good target consumer, what product types/brands certain consumers purchase, and the like. Such analytics may be helpful in targeting consumers to maximize coupon distribution, coupon use and the like. Some embodiments may also assist in promoting word of mouth brand advocacy from brand loyal customers to potential customers. Some embodiments provide for the analytical component 75 to generate one or more reports to be based on analysis of the tracked coupon data.

In some embodiments, a widget may be deployed as (or otherwise interfaced with) an application on the retail store's or incentive program's website, a third party website, a social media website and/or service (such as Myspace, Facebook, Twitter and the like). In one example, a widget to be made available on a consumer's blog or other consumer-operated website.

Some embodiments contemplate creating a coupon exchange site to facilitate the controlled swapping of coupons. A widget may also be implemented to take advantage of social media channels as a way of distributing coupons to friends for those offers the retail store may deem appropriate. Widgets and/or applications may be implemented with third party social media channels such as Twitter and Facebook, for example. Facebook, for example, has released two “open-stream” application programming interfaces (APIs), which allow developers access to the Facebook data stream, and which may allow access to their connections.

The exchange mechanism may be set with variable limits such that coupons may only be transferred once, to allow transferring a coupon only to direct contacts (or “friends”), or to allow only a limited amount of uses for close associates. For example, a beer voucher may be targeted at Fourth of July parties and only allow forwarding once, so that only people the consumer invites to their Fourth of July party may redeem it. For a larger distribution, friends and their guests may be allowed to receive coupons.

Several example embodiments are now provided to elaborate on possible implementations of the systems and methods described herein. For discussion purposes, the following embodiments occur between two consumers, Consumer 1 (the coupon transmitter) and Consumer 2 (the coupon recipient). It is to be understood that these example embodiments are illustrative of some potential implementations of the systems and method described herein, and that it is within the scope of the system and methods described herein to provide many other potential implementations.

### EXAMPLE A

### Consumers 1 and 2 are Retail Store Program Members, but Consumer 2 has Not Previously Used the Coupon Transfer System/Method

Consumer 1 is a loyal customer that receives a letter or an electronic communication from the retail store including a “high value” coupon as a thank you for purchasing a certain brand and/or product, and a set of “smaller value” coupons to let his friends (such as Consumer 2) share the benefit of the brand and/or product. Only one coupon may be associated with any given member, so Consumer 1 will only be able to redeem the “high value” coupon, but may send the “smaller value” coupons to others (it is also, of course, possible that the coupons could have the same values or even that Consumer 1's coupon have the smaller value).
Consumer 1 visits the retail store website (or other entity websites or portals as discussed herein) to pass on coupons. A list of coupons may be available to pass on. The website/portal may also provide an option to input a friend's email address and a message to the friend. Consumer 1 inputs Consumer 2's email address to transfer the coupon to Consumer 2.
Consumer 2 receives an email or other electronic notice or communication stating that Consumer 1 has sent them a message and a chance to enjoy Consumer 1's favorite brand and/or product. The email/notice includes a button (or other link) to the retail store's website.
Consumer 2 follows the link to the website where there is a copy of the message and an option to accept the coupon. The website also requests Consumer 2 to input their member number (or enter a password or other information associated with the number) to associate the coupon with Consumer 2's member number. To limit abuse, a checking mechanism may check that Consumer 2's name/email address corresponds to the name/email address provided by Consumer 2 when Consumer 2 initially registered for the retail store program.
Consumer 2 visits the retail store and uses their member number (by presenting a loyalty card or other identifying item, for example) to automatically redeem the “smaller value” coupon when purchasing the brand and/or product.

### EXAMPLE B

### Consumers 1 and 2 are Both Retail Store Members and Consumers 1 and 2 have Both Previously Used the Coupon Transfer System/Method

Consumer 1 is a loyal customer that receives a letter or an electronic communication from the retail store including a “high value” coupon as a thank you for purchasing a certain brand and/or product, and a set of “smaller value” coupons to let his friends (such as Consumer 2) share the benefit of the brand and/or product. Only one coupon may be associated with any given member, so Consumer 1 will only be able to redeem the “high value” coupon, but may send the “smaller value” coupons to others.
Consumer 1 visits the retail store website to pass on coupons. A list of coupons may be available to pass on. The website may also provide an option to input a friend's email address and a message to the friend. Consumer 1 inputs Consumer 2's email address to transfer the coupon to Consumer 2.
Consumer 2 receives an email or other electronic notice or communication stating that Consumer 1 has sent them a message and a chance to enjoy Consumer 1's favorite brand and/or product. The email includes a button (or other link) to accept the coupon.
Consumer 2 visits the retail store and uses their member number (by presenting a loyalty card or other identifying item, for example) to redeem the “smaller value” coupon when purchasing the brand and/or product.

### EXAMPLE C

### Consumer 1 is a Retail Store Program Member, but Consumer 2 is Not a Retail Store Loyalty Program Member

Consumer 1 is a loyal customer that receives a letter or an electronic communication from the retail store including a “high value” coupon as a thank you for purchasing a certain brand and/or product, and a set of “smaller value” coupons to let his friends (such as Consumer 2) share the benefit of the brand and/or product. Only one coupon may be associated with any given member, so Consumer 1 will only be able to redeem the “high value” coupon, but may send the “smaller value” coupons to others.
Consumer 1 visits the retail store website to pass on coupons. A list of coupons may be available to pass on. The website may also provide an option to input a friend's email address and a message to the friend. Consumer 1 inputs Consumer 2's email address to transfer the coupon to Consumer 2.
Consumer 2 receives an email stating that Consumer 1 has sent them a message and a chance to enjoy Consumer 1's favorite brand and/or product. The email includes a button (or other link) to accept the coupon.
Consumer 2 follows the link to the website where there is a copy of the message and an option to accept the coupon. The website also requests Consumer 2 to input their member number to associate the coupon with their member. The website also provides an option that states “I'm not a member, but I want to sign up now.” Since Consumer 2 is not a member, he/she follows that option to sign up for membership.
After Consumer 2 finishes signing up and receives a member number, message is displayed that says the coupon was added to Consumer 2's member number. Also, instructions are displayed describing how to redeem the coupon before the membership information arrives through the mail system.
Consumer 2 visits the retail store and uses their member number (by presenting a loyalty card or other identifying item, for example) to redeem the “smaller value” coupon when purchasing the brand and/or product.

### EXAMPLE D

### Consumers 1 and 2 are Retail Store Members, but Consumers 1 and 2 have Not Previously Used the Coupon Transfer System/Method

Consumer 1 invites the retail store to be “friends” on a third party social media website such as Facebook.
Consumer 1 receives a gift from the retail store. The gift includes a package of coupons for use at the retail store, including a “high value” coupon and a set of “smaller value” coupons.
Consumer 1 accepts the package of coupons.
Consumer 1 selects the “high value” coupon from the package of coupons to store on (or associate with) Consumer 1's member number. This may require Consumer 1 to input their member number.
Consumer 1 identifies one or more “friends” to receive the “smaller value” coupons from the package of coupons. Consumer 2 is one the friends that Consumer 1 identifies.
Consumer 2 receives the “smaller value” coupon gift from Consumer 1.
Consumer 2 accepts the “smaller value” coupon to store on (or associate with) Consumer 2's member number. This may require Consumer 2 to input their member number.
Consumer 2 visits the retail store and uses their member number (by presenting a loyalty card or other identifying item, for example) to redeem the “smaller value” coupon.

### EXAMPLE E

### Product Launch

Consumer 1 receives a letter or an electronic communication from a retailer with a coupon promoting a new product, requesting that the consumer try the new product and if the consumer likes the new product to then visit a certain website or some other electronic space (or come back to the same space where the initial communication was received) to obtain a second coupon for use on a subsequent purchase.
When Consumer 1 returns to obtain the second coupon, Consumer 1 is offered one or more additional coupons that can be passed along to Consumer 1's friends or network (with the hope that Consumer 1 will also relay that they liked the product and recommend that the friend try it).

### EXAMPLE F

### Electronic Shopping List

Consumer 1 accesses a website or other similar electronic space or portal to build a shopping list of products for Consumer 1's next shopping visit;
Consumer 1 accesses the shopping list using Consumer 1's mobile communication device while at the retail establishment;
While at the retail establishment, Consumer 1 is issued one or more coupons based upon the contents of Consumer 1's shopping list directly to Consumer 1's mobile communication device (the redeemable bar-codes of such coupons can be displayed, for example, on the screen of the mobile phone at check-out or the coupons can be automatically associated with Consumer 1's loyalty account so that they will be automatically applied at checkout).
Alternatively, such coupons issued to the mobile phone (or notified by the mobile phone as being loaded on the loyalty card account) can be for items on the shopping list and/or not on the shopping list. For example, if the retailer portal includes algorithms for identifying recipe holes (e.g., the shopping list includes all the ingredients for a pasta dinner, except for grated cheese or Italian bread), then the algorithms can be configured to transmit coupons directed to those recipe holes. Or if the retailer portal includes algorithms for identifying staple items that Consumer 1 rarely purchases, then the algorithms can be configured to transmit coupons directed to those staple items.

In some of the above examples or other examples, rather than a letter or some form of electronic communication being initially sent to Consumer 1, Consumer 1 can access the coupon offer by clicking-on (or activating in some other known manner) a banner ad or some other form of hyper-link on a website or other portal. For example, a blog can recommend a new product and include a link to an initial coupon offer to Consumer 1.

### EXAMPLE G

### Party Invitation

Consumer 1 accesses a website or other similar electronic space or portal to build create party invitations to Consumer 1's friends or network.
Consumer 1, as part of this invitation creation process, can ask the invitees to bring a dish or some other consumable to the party and can use the website or portal to transmit coupons along with the electronics party invitations that the invitees could use for purchasing the items to bring to the party.

### EXAMPLE H

### Building Brand Awareness

Consumer 1 is a loyal customer that receives a letter or an electronic communication from the retail store including a “extreme high value” one-time-use coupon that most consumer's are unlikely to need (e.g., a “free turkey” coupon a day before Thanksgiving because most consumers have already purchased their turkey by that time, or for “free bag of large-breed dog food” since many consumers will not have large dogs), with unlimited ability for Consumer 1, and friends and network associations to pass along until a Consumer is found who wants or needs the coupon. By passing the coupon around to friends and network until it is finally used, those who receive the “extreme high value” coupon may have a better brand awareness from that point forward.

In some examples, the coupon may include an image and may be stored within a user list database. The coupon may also contain a reference to an image, such as a URL, such that an image server stores all images rather than the database. In one example, practicalities around efficient response times and scalability may guide decisions regarding such structure. In other embodiments, the coupon structure may include a table to itself with a reference to it in the user database record, or it could actually sit within a list for a user.

In one embodiment, a marketing platform may be utilized to implement the systems and/or methods described herein. Marketing platforms such as those manufactured by Agillic may be utilized in multichannel distribution of coupons, marketing on demand services and other coupon marketing activities. Agillic, for example, provides efficient interfacing with email, mobile devices and other channels.

In some embodiments, the system may enable the propagation of coupons through electronic media including but not limited to social media websites and services (e.g., Twitter and Facebook) and/or other electronic communications channels (e.g., text and email). The coupons may be exchangeable and transferable in a manner that mimics a physical coupon. For example, if customer A passes a coupon to customer B, then customer A no longer has the coupon. In some embodiments, a coupon ownership file may include information to be sent to retailers (or made accessible by the retailers) so that the retailers may allow redemption for the coupon owner (or holder) at the Point of Sale (PoS).

In one embodiment, to allow widgets to communicate with the database(s), a set of services may be utilized. This set of services may also enable communication with retailers and with third party marketing organizations running the promotions. In one embodiment, the services may be subdivided into three sections. These may include a retailer interface to allow the retailer to service coupons, an administrator interface to allow an administrator to create and manage coupons, and a consumer interface to allow consumers to collect and manage coupons.

In an example embodiment, the retail interface may allow access by one or more retailers. Such a retail interface may allow retailers to access data concerning their own members and/or coupons. For example, if a manufacturer issues a coupon that is identical to that of a retailer, then a retailer may only access data relating to their own version of that coupon. Retailers may also download and/or manage a list of members and the coupons associated therewith. Retailers may also burn a target list of redeemed coupons. Retailers may also burn a particular coupon for all customers. “Burning” a coupon may remove it from the coupons made available to a consumer. Depending on the burn type of the coupon, the coupon may be moved to a set of coupons available for issue or removed from the database altogether. Burning can be used to expire coupons using a “burntype 1” or give up rights to a coupon with “burntype 2.”

In an example embodiment, the administrator interface may allow access by one or more administrators. The administrator interface may provide many functions to system administrators. Such functions may include creating coupons, editing the settings for a coupon, uploading a target list, sending a primary coupon to a target list, sending secondary coupons to a target list, creating a coupon package (which may include a primary coupon and secondary coupons), sending a coupon package to a target list, extracting a list of all consumers associated with a particular coupon, burning all instances of a particular coupon and burning a coupon from a given consumer, among other functions. In some embodiments, the administrator interface may also provide access to consumer member numbers, email addresses and/or other identifying information (e.g., Twitter username, Facebook username, mobile device information, credit card information, etc.). Additional functions may include burning a coupon from a consumer target list, uploading a set of consumer details, uploading a group of consumer details sets and extracting a list of all consumers who received a coupon initially sent to a given consumer. The administrator interface may also provide complete control regarding burn type. Of course, it is within the scope of the disclosure that all such functions can be provided without the use of an administrator interface, such as through a retailer interface and/or a CPG interface and/or through any other interface.

In an example embodiment, the administrator interface may allow access by one or more consumers. The consumer interface may provide many functions to consumers. Such functions may include accepting a coupon from another consumer (with an optional reply message), refusing a coupon from another consumer (with an optional reply message), adding a coupon to the consumer's member number, forwarding a coupon (with an optional message), offering a coupon for exchange, burning a coupon (or a “type 2 burn”), checking coupons available for sending, checking coupons available for redemption, removing a coupon from the consumer's member number.

Such interfaces may be implemented in many different platforms, including online widgets, email widgets, mobile widgets, and/or within social media platforms. In one embodiment, an online widget is provided that allows consumers to log on and/or off to manage and interact with the coupon system. In one embodiment, an email widget may be accessed and utilized within an email when displayed with an email client (via server-side email service and/or client-side email application, for example). Such an email widget may also utilize a link to a website that incorporates an online widget. In one embodiment, a mobile widget may provide access to the coupon system via mobile devices (such as mobile phones, for example). In some embodiments, the mobile widget may be divided into a set of separate interfaces, including a fully functioning mobile widget for use with smart phones, a limited functioning mobile widget (to accept coupons and add them to a member number, for example) for non-smart phones, and a customized mobile widget for use with a particular mobile (such as Apple Inc.'s IPHONE@ mobile phone or Research In Motion's BLACKBERRY® mobile phones, for example).

In some embodiments, social media platform widgets and/or applications may provide integrated coupon management from within the social media platform. For example, in an application integrated with Twitter, a user may be able to supply the coupon system application their account login credentials for Twitter. The coupon system application may allow a consumer to select another consumer to contact with a coupon offer. That consumer may then be sent a direct message using Twitter. Such a message may include a URL to the online widget for acceptance of the coupon. In one embodiment, the list of consumers from which a consumer may contact will be determined from the Twitter API. Further, once account login credentials are supplied, the coupon system application may allow a consumer to broadcast a message via Twitter to all of their followers with a URL to the online widget for acceptance of the coupon.

In some embodiments, social media platforms may be helpful in providing brand messaging and/or coupons to a large amount of consumers. Continuing with the Twitter example, in addition to direct messages, a consumer may generate broadcast messages that may be viewable by other Twitter members who may be “following” the consumer. Further, broadcast messages may be viewable by any consumer (whether or not a Twitter user) who navigates to the Twitter user's page.

In some embodiments, since the coupon website may be used in conjunction with a variety of retailers, it may be configured as a template for each retailer to allow co-branding between the marketing/promotions company and the retailer. A template may include space for an advertisement (which may include images, text and/or videos).

In some embodiments, one or more databases may be utilized to store information related to consumers, coupons, tracking, connections and the like. A consumer database may store and/or link to consumer names, member numbers, email addresses, telephone numbers, loyalty card numbers, unique IDs, Twitter IDs, Facebook IDs, active coupons lists, owned coupons lists, offered coupons lists, mappings from friends to offered items, friends list and other similar consumer details. A coupon database may store and/or link campaign numbers, coupon numbers, the number of coupon exchanges available, the number of coupon exchanges initially allowed, coupon customer images, coupon customer text, coupon brand colors, coupon brand images or other similar coupon details. A tracking database may store and/or link tracking details and/or consumer actions (e.g., offer a coupon from consumer A to consumer B using method X, acceptance of the coupon by consumer B from consumer A via method X, refusal of the coupon by consumer B from consumer A via method X, redemption of the coupon by consumer A, burning of the coupon by consumer A, etc.). A connections database may store and/or link connections and/or relationships among consumers. Such a database may include data on how influential the connection is (in terms of redemption rates or load to card rates, for example), when the coupon was last used and how frequently the coupon is used. These databases (and others) may be combined within a single database or distributed among multiple databases.

In some examples, some or all administrator, retailer and/or consumer actions may be logged, in addition to logging of errors associated with the coupon system. Example data stored in the log files may include who has been offered a coupon of what type by what media type and by whom, who has accepted a coupon of what type by what media type and from whom, who has refused a coupon of what type by what media type and from whom, who has forwarded a coupon of what type by what media type and to whom, who has added what coupon of what type to their member number including details of how they received it and from whom, and who has removed what coupon of what type from their member number including details of how they originally received it and from whom.

Some embodiments may provide for communications (via email, text messaging, social media platforms or other electronic communications channels) to consumers to remind them of when coupons may expire, when new coupons have been offered, when coupons have been withdrawn and other related communications.

In some embodiments, coupons may be shared, passed and/or transmitted between different media types. For example, and without limitation, consumer A may receive the coupon via email, but transmit the coupon to consumer B via text message or the like to consumer B's cell phone.

In some embodiments, the coupon system may function as a coupon exchange website where consumers may swap coupons among each other. For example, consumer A may agree to swap two coupons for brand X with consumer B who has one coupon for brand Y. The exchange website may facilitate the swap to make sure that both consumer A and consumer B actually transfers the coupons as agreed.

Some coupons may have restrictions associated therewith, while other coupons may have no restrictions. For example, a coupon may be able to be redeemed once (e.g., a “single use” coupon). Some coupon may be able to be redeemed a predetermined number of times. For example, a retail store may restrict a particular coupon's redemption limit to ten uses. After that coupon has been redeemed ten times, the coupon would be deemed expired and/or non-redeemable. Some coupons may include transfer limits restricting unlimited transfer of the coupon. Some coupons may be limitless, as they may have no restrictions related to redemption and/or transfer. Further, some coupons may have restrictions limiting the amount of uses and/or transfers by a particular consumer. For example, a coupon may be “limitless” regarding the total number of redemptions and/or transfers allowed, but may be restricted such that a consumer may only redeem and/or transfer the coupon once. Subsequent attempts by the same consumer may not be allowed. In this manner, the coupon may be deemed expired, non-redeemable and/or non-transferable for that particular consumer, but not others. Some embodiments may allow for a consumer to request additional coupons (after a first redemption and/or transfer) for subsequent transfer to their friends and/or acquaintances.

In some embodiments, the coupon system may associate parameters with each coupon to effectively monitor and manage coupon transfer and redemption. For example, parameters may include transfer limit parameters (which may include a limit, if appropriate, on the number of times a coupon may be sent from one consumer to another), expiration parameters (which may include a date after which a coupon ceases to function), eXtensible Markup Language (XML) parameters (which may include XML code describing how a coupon matches different retailer schemas), and viral sending parameters (which may include limitations on the total quantity of coupons to limit coupon redemption abuse).

In some embodiments, the coupon is usable in all retail establishments (even those not associated with the retail entity's loyalty program or those not associated with the incentive program); but if the coupon is redeemed in a certain retail establishment and associated with the consumer's loyalty account or partnered with the incentive program, then the consumer could be awarded with incentive points (e.g., for discounts in gasoline purchase and the like) or other types of rewards or incentives that can be associated with the loyalty program, incentive program, credit card or other account associated with the consumer.

To provide additional context for various aspects of the present invention, the following discussion is intended to provide a brief, general description of a suitable computing environment in which the various aspects of the invention may be implemented. While one embodiment of the invention relates to the general context of computer-executable instructions that may run on one or more computers, those skilled in the art will recognize that the invention also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the invention may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the invention may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media may provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and/or a pointing device, such as a mouse. Other input devices may include a microphone (functioning in association with appropriate language processing/recognition software as know to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A system for transmitting a plurality of coupons among a plurality of consumers, comprising:
at least one consumer database, each consumer database configured to store consumer data related to at least one of the plurality of consumers' biographical information, contact information, identifying information and membership information;
at least one coupon database, each coupon database configured to store coupon data related to at least one of a plurality of coupons, wherein the plurality of coupons comprises at least one of product discounts, product offers and product advertisements;
a coupon request component configured to receive a request from a first consumer of the plurality of consumers to transmit at least one of the plurality of coupons to a second consumer of the plurality of consumers, wherein the coupon request component interfaces with at least one of a social media channel and an electronic communications channel;
an authentication component in communication with the at least one consumer database, the authentication component configured to authenticate the first consumer based, at least in part, on the consumer data stored in the at least one consumer database, and further configured to authenticate the second consumer based, at least in part, on the consumer data stored in the at least one consumer database;
a coupon transmission component configured to transmit the requested at least one of the plurality of coupons to the second consumer upon authentication of the first consumer and the second consumer; and
a coupon tracking component configured to associate each of the plurality of coupons with at least one consumer of the plurality of consumers, and further configured to store the associations in the at least one coupon database.

2. The system of claim 1, wherein the social media channel comprises at least one of a website, a widget, an application and computer-readable instructions.

3. The system of claim 1, wherein the electronic communications channel comprises at least one of a text messaging channel, a multimedia messaging channel and an email channel.

4. The system of claim 1, wherein each of the plurality of coupons is associated with a unique coupon identifier stored in the at least one coupon database.

5. The system of claim 4, wherein each unique coupon identifier is associated with only one of the plurality of consumers at a time.

6. The system of claim 1, wherein the coupon data further comprises a unique coupon identifier, wherein the unique coupon identifier may be associated with only one of the plurality of consumers at a time.

7. The system of claim 6, wherein, upon transmitting the coupon to the second consumer, the unique coupon identifier is associated with the second consumer and disassociated with the first consumer.

8. The system of claim 7,
wherein the coupon data associated with the transmitted coupon is linked to the consumer data of the second consumer; and
wherein the coupon data associated with the transmitted coupon is unlinked to the consumer data of the first consumer

9. The system of claim 1, wherein the transmitted coupon may only be redeemed by the second consumer if the coupon data for the transmitted coupon is associated with the second consumer's consumer data.

10. The system of claim 1, wherein the transmitted coupon may only be redeemed by the second consumer if the coupon data for the transmitted coupon is associated with the second consumer's loyalty card information.

11. The system of claim 1, wherein, upon transmission of the requested coupon to the second consumer, the first consumer is restricted from redeeming the transmitted coupon.

12. The system of claim 1, wherein, upon transmission of the requested coupon to the second consumer, the second consumer is restricted from further transmitting the transmitted coupon.

13. The system of claim 1, wherein the plurality of coupons comprises a first coupon associated with a product and second coupon associated with the product, wherein the first coupon provides a discount of greater value than the second coupon.

14. The system of claim 1, wherein the plurality of coupons provided to the first consumer is based, at least in part, on at least one of the first consumer's transaction history.

15. The system of claim 14, wherein the plurality of coupons provided to the first consumer is based, at least in part, on the first consumer's tendency to purchase a certain product brand.

16. The system of claim 1, wherein the plurality of coupons comprises at least one of a manufacturer's coupon and retailer's coupon.

17. The system of claim 1, wherein the plurality of coupons comprise at least one of text, an image, a video and a link to at least one of the text, the image and the video.

18. The system of claim 1, wherein the second consumer may temporarily disassociate one or more of the plurality of coupons from the second consumer to restrict usage of the coupon by the second consumer.

19. The system of claim 1, wherein at least one of the plurality of coupons may be redeemed at at least one of a physical retail store and a virtual retail store.

20. The system of claim 1, further comprising:
a coupon reservation component in communication with at least one of the coupon tracking component, the coupon request component and the authentication component, the coupon reservation component configured to reserve at least one coupon of the plurality of coupons for at least one particular consumer of the plurality of consumers.

21. The system of claim 20, wherein the reserved at least one coupon of the plurality of coupons may only be redeemed by the at least one particular consumer.

22. The system of claim 1, wherein at least one of the coupon tracking component, the coupon request component and the authentication component is further configured to reserve at least one coupon of the plurality of coupons for at least one particular consumer of the plurality of consumers.

23. The system of claim 1,
wherein the electronic communications channel comprises an electronic shopping list portal configured to create an electronic shopping list;
wherein the coupon transmission component is further configured to transmit at least one of the plurality of coupons associated with at least one shopping list item on the electronic shopping list to at least one of the plurality of consumers.

24. The system of claim 1,
wherein the electronic communications channel comprises an electronic event invitation portal configured to create an event invitation list for transmission to a plurality of invitees, the event invitation list comprising a plurality of requested event items for the plurality of invitees to purchase for an event;
wherein the coupon transmission component is further configured to transmit at least one of the plurality of coupons associated with at least one requested event item on the event invitation list to at least one of the plurality of invitees.

25. The system of claim 1, wherein the second consumer receives the requested at least one of the plurality of coupons using the second consumer's mobile phone.

26. The system of claim 1, further comprising an analytical component configured to analyze tendencies of consumers participating with certain aspects of the system.

27. The system of claim 26, wherein the analytical component is further configured to generate a report based upon at least a portion of its analysis.

28. The system of claim 27, wherein the analytical component is further configured to provide access to at least one of product manufacturers and service providers associated with the coupons.

29. A method of transmitting a coupon associated with a product or service among a plurality of consumers, the method comprising:
transmitting to a first consumer a coupon, via an electronic distribution channel, the coupon having an associated unique coupon identifier, the first consumer having a first consumer identification number associated with at least one of a retail entity and an incentive program;
associating, in a coupon database, the unique coupon identifier with the first consumer identification number;
receiving a request from the first consumer to transmit the coupon, via an electronic distribution channel, to a second consumer, the request being initiated from at least one of a social media channel and an electronic communications channel;
transmitting the coupon to the second consumer via an electronic distribution channel; and
associating, in the coupon database, the unique coupon identifier with a second identification number of the second consumer associated with the at least one of the retail entity and the incentive program.

30. The method of claim 29 further comprising the step of, in conjunction with or following the step of transmitting the coupon to the second consumer, disassociating, in the coupon database, the unique coupon identifier from the first consumer identification number.

31. The method of claim 29 further comprising:
receiving a request from the first consumer to transmit the coupon, via an electronic distribution channel, to another consumer, the request being initiated from at least one of a social media channel and an electronic communications channel;
transmitting the coupon to the other consumer via an electronic distribution channel; and
associating, in the coupon database, the unique coupon identifier with an identification number of the other consumer associated with the at least one of the retail entity and the incentive program.

32. The method of claim 31, further comprising repeating the steps of claim 28.

33. The method of claim 32, wherein the repeating step is performed until a preset limit on coupon transmissions associated with the coupon is met.

34. The method of claim 29 further comprising:
reserving the coupon for the second consumer's identification number so that the coupon can only be accepted and/or redeemed by the second consumer.

35. The method of claim 29, further comprising:
redeeming the coupon with respect to a transaction with at least one of a physical retail store and a virtual retail store by the second consumer using the second consumer identification number.

36. The method of claim 35, further comprising:
after or substantially simultaneous with the redeeming step, disassociating, in the coupon database, the unique coupon identifier from the second identification number.

37. The method of claim 29, further comprising:
prior to or substantially simultaneous with the step of associating, in the coupon database, the unique coupon identifier with a second identification number, registering the second consumer with at least one of the retail entity and the incentive program, the registration step assigning the second identification number to the second consumer.

38. The method of claim 37, wherein the registering step occurs after the step of transmitting the coupon to the second consumer via the electronic distribution channel.

39. One or more web servers configured to perform the method of claim 29.

40. One or more computer-readable mediums having instructions thereon, the instructions configured to perform the method of claim 29.

41. A method of transmitting a plurality of coupons associated with a product or service among a plurality of consumers, the method comprising:
transmitting to a first consumer a first coupon, via an electronic distribution channel, the first coupon having an associated first unique coupon identifier, the first consumer having a first consumer identification number associated with at least one of a retail entity and an incentive program;
associating, in a coupon database, the first unique coupon identifier with the first consumer identification number;
receiving a request from the first consumer to transmit a second coupon having an associated second unique coupon identifier to a second consumer, wherein the second coupon provides an incentive of different value than the first coupon, the request being initiated from at least one of a social media channel and an electronic communications channel;
authenticating the second consumer to determine if the second consumer is registered with the at least one of the retail entity and the incentive program, and has been assigned a second consumer identification number;
transmitting the second coupon to the second consumer via an electronic distribution channel if the second consumer is authenticated; and
associating, in the coupon database, the second unique coupon identifier with the second consumer identification number.

42. The method of claim 41, further comprising:
after or substantially simultaneous with a redemption of the first coupon, disassociating, in the coupon database, the first unique coupon identifier from the first consumer identification number.

43. The method of claim 41, further comprising:
after or substantially simultaneous with a redemption of the second coupon, disassociating, in the coupon database, the second unique coupon identifier from the second consumer identification number.

44. The method of claim 41, wherein the step of transmitting to the first consumer the first coupon includes a step of transmitting to the first consumer the second coupon.

45. The method of claim 41, wherein the first coupon has a higher incentive value than the second coupon.

46. One or more web servers configured to perform the method of claim 41.

48. One or more computer-readable mediums having instructions thereon, the instructions configured to perform the method of claim 41.

49. One or more memory devices having software operating thereon, the software being configured to perform the method of claim 41.

50. A system for transmitting a plurality of coupons among a plurality of consumers, comprising:
means for transmitting to a first consumer a coupon, via an electronic distribution channel, the coupon having an associated unique coupon identifier, the first consumer having a first consumer identification number associated with at least one of a retail entity and an incentive program;
means for associating, in a coupon database, the unique coupon identifier with the first consumer identification number;
means for receiving a request from the first consumer to transmit the coupon, via an electronic distribution channel, to a second consumer, the request being initiated from at least one of a social media channel and an electronic communications channel;
means for transmitting the coupon to the second consumer via an electronic distribution channel; and
means for associating, in the coupon database, the unique coupon identifier with a second identification number of the second consumer associated with the at least one of the retail entity and the incentive program.

51. The system of claim 50 further comprising means for, disassociating, in the coupon database, the unique coupon identifier from the first consumer identification number in conjunction with or following the transmitting the coupon to the second consumer.

52. The system of claim 50 further comprising:
means for receiving a request from the first consumer to transmit the coupon, via an electronic distribution channel, to another consumer, the request being initiated from at least one of a social media channel and an electronic communications channel;
means for transmitting the coupon to the other consumer via an electronic distribution channel; and
means for associating, in the coupon database, the unique coupon identifier with an identification number of the other consumer associated with the at least one of the retail entity and the incentive program.

53. The system of claim 52, further comprising means for repeating the receiving, transmitting and associating functions of claim 52.

54. The system of claim 52, further comprising means for repeating the receiving, transmitting and associating functions of claim 52 until a preset limit on coupon transmissions associated with the coupon is met.

55. The system of claim 50 further comprising:
means for reserving the coupon for the second consumer's identification number so that the coupon can only be accepted and/or redeemed by the second consumer.

56. The system of claim 50, further comprising:
redeeming the coupon with respect to a transaction with at least one of a physical retail store and a virtual retail store by the second consumer using the second consumer identification number.

57. The system of claim 56, further comprising:
means for disassociating, in the coupon database, the unique coupon identifier from the second identification number after or substantially simultaneous with the redeeming function of claim 56.

58. The system of claim 50, further comprising:
means for registering the second consumer to the with at least one of the retail entity and the incentive program prior to or substantially simultaneous with the function of associating, in the coupon database, the unique coupon identifier with a second identification number.

59. The method of claim 58, wherein the registering function occurs after the function of transmitting the coupon to the second consumer via the electronic distribution channel.
